(19) United States
(12) Patent Application Publication
(10) Pub. No.: US 2005/0158013 A1
(43) Pub. Date: Jul. 21, 2005

(54) Integrated multimedia microcomputer device

(76) Inventors: Wen-Hsuan Sun, Hsin-Chu (TW); Chia-cheng Yeh, Hsin-Chu (TW); Chih-Shiung Chiang, Taipei (TW); Chien-Chung Kuo, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/829,333

(22) Filed: Apr. 22, 2004

(30) Foreign Application Priority Data
Jan. 6, 2004 (TW) 93200821

(51) Int. Cl. H04N 9/87

(52) U.S. Cl. 386/4

(57) ABSTRACT

An integrated multimedia microcomputer device comprises a system-on-a-chip including a general purpose processor, a audio processor and an video processor. The general purpose processor is used to process an operation system and a plurality of application programs. The integrated multimedia microcomputer device also comprises a memory for storage of data, a audio/video output interface connected with the audio processor and the video processor for output of processed audio and video data respectively. The general purpose processor is also connected with a storage medium interface and several connection interfaces for electric connection with memory media and external electronic devices. The general purpose processor can perform signal transmission and communication with these electronic devices through execution of the application programs to accomplish the effects of multiple choices, convenient expansion of devices and audio/video playback.

### FIELD OF THE INVENTION

The present invention relates to a multimedia device and, more particularly, to an integrated multimedia microcomputer device capable of processing and executing an operation system and application programs.

### BACKGROUND OF THE INVENTION

Along with continual progress of the information technology, various kinds of electronic information products like mobile phones, notebook computers, DVD players, digital still cameras and so on, provide different applications such as audio/video multimedia and network data transmission in everyday of people lives. Originally, the conventional playback devices like DVD players, MP3 players or card readers are independent products respectively. In order to meet people's requirements on multimedia playback, the products capable of several media playback have been developed gradually.

However, the existing multimedia devices only possess video and audio playback functions, but are inadequate in derivative functions. They can't handle the complex operations, and are limited to few number of connection interfaces. These devices are not so desirable to meet the requirement of a high-integrated multi-functions electronic device.

Accordingly, the present invention proposes an integrated multimedia microcomputer device capable of executing operation systems and application programs to solve the problems in the prior art. The integrated multimedia microcomputer device can not only play multimedia, but provide the flexibly selectable and expansible electronic devices to users.

### SUMMARY AND OBJECTS OF THE PRESENT INVENTION

The primary object of the present invention is to provide an integrated multimedia microcomputer device, wherein a system-on-a-chip (SOC) and various interfaces are integrated together. The SOC is used to execute operation systems and application programs for accomplishing the effects of processing multimedia data and multiple selections of entertainment items.

Another object of the present invention is to provide an integrated multimedia microcomputer device to provide flexibly selectable electronic devices and also have the advantage of convenient expansibility.

Another object of the present invention is to provide a microcomputer device integrating multimedia and car navigation, which not only can renew map information anytime, but also can play navigation data with voice to provide more dynamical navigation functions.

According to the present invention, an integrated multimedia microcomputer device comprises a memory, a system-on-a-chip (SOC), a audio/video output interface, at least a storage medium interface and a plurality of connection interfaces. The SOC comprises a general purpose processor electrically connected with a audio processor and an video processor. The memory provides storage of at least an operation system and a plurality of application programs. The general purpose processor is used to process and execute the operation system and application programs. The audio/video output interface is connected with the audio processor and the video processor for output of audio and video respectively. The storage medium interface is connected with the general purpose processor for electric connection with a storage medium. The connection interfaces are connected with the SOC for electric connection with a plurality of external electronic devices. The general purpose processor can thus accomplish signal connection with these electronic devices through execution of the application programs.

The various objects and advantages of the present invention will be more readily understood from the following detailed description when read in conjunction with the appended drawings, in which:

### BRIEF DESCRIPTION OF DRAWINGS

FIG. 1 is an architecture block diagram of the present invention;

FIG. 2 is a detailed structure block diagram of the present invention;

FIG. 3 is a summary diagram showing application systems of the present invention;

FIG. 4 is a diagram showing a main menu of the present invention; and

FIG. 5 is a diagram showing a GPS navigation submenu of the present invention.

### DETAILED DESCRIPTION OF PREFERRED EMBODIMENT

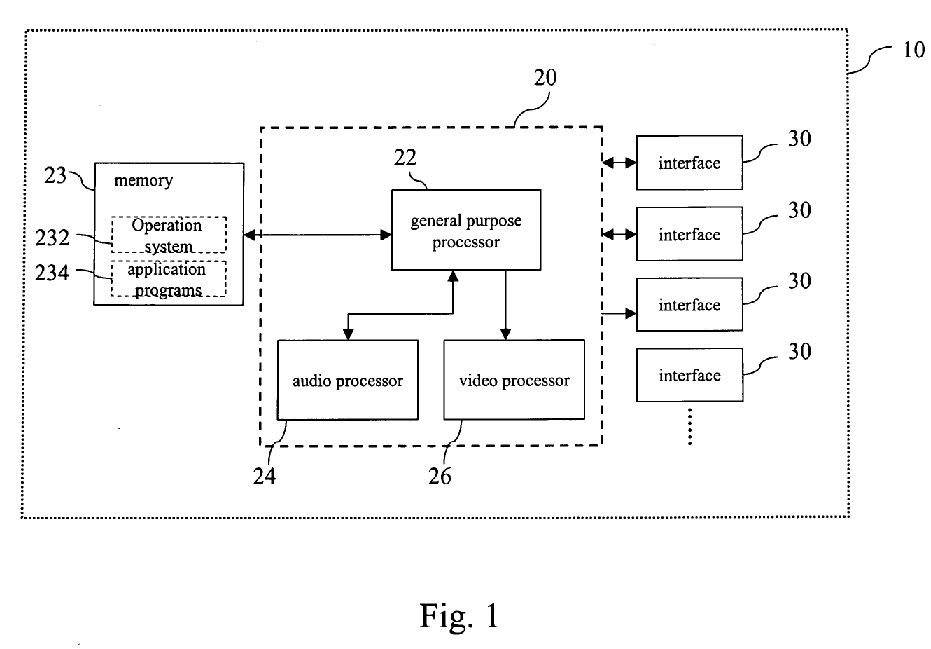

As shown in FIG. 1, an integrated multimedia microcomputer device 10 comprises a system-on-a-chip (SOC) 20, a memory 23 and a plurality of interfaces 30. These interfaces 30 provide electric connection with a plurality of external devices. The memory 23 provides the space for data storage, like an operation system (OS) 232 and a plurality of application programs 234. The OS 232 and the application programs 234 can be downloaded from external electronic devices, or can be built in the memory 23. The SOC 20 comprises a general purpose processor 22 electrically connected with a audio processor 24 and an video processor 26. The general purpose processor 22 is used for execution and processing of the OS 232 and the application programs 234. The OS 232 is generally a real-time OS. Depend on different designs, the application programs 234 can cover the different real demands. The general purpose processor 22 integrates the operation procedures between the interfaces 30 and the audio processor 24 and the video processor 26. The audio processor 24 performs encoding/decoding and processing of audio. The video processor 26 performs encoding/decoding and processing of video. Generally, the audio file formats processed by the audio processor 24 are MP3, AC3, DTS, WMA and Karaoke. The audio processor 24 can also perform conversion from text to voice (Text-to-speech). The video file formats processed by the video processor 26 include MPEG1, MPEG2, MPEG4, DivX, JPEG, M-JPEG and WMV.

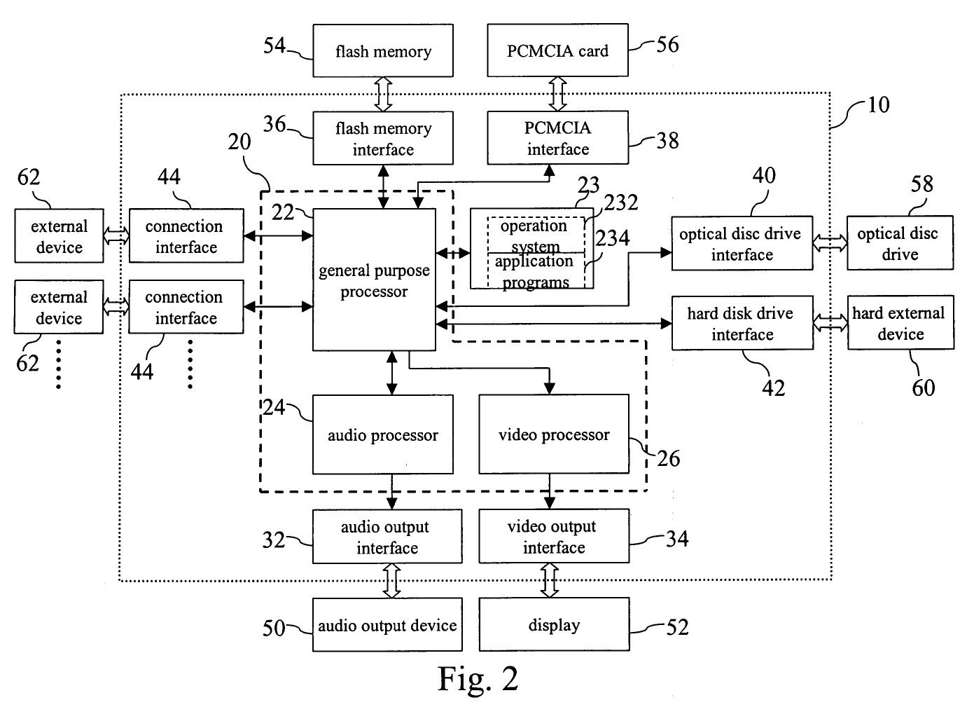

As shown in FIG. 2, the interfaces comprises a audio output interface 32, an video output interface 34, four storage medium interfaces 36, 38, 40 and 42, and a plurality of connection interfaces 44. The audio output interface 32 and the video output interface 34 are connected to the audio processor 24 and the video processor 26 for connection with a audio output device 50 and a display 52 for output of audio and video, respectively. The audio output interface 32 is generally a two-channel stereo interface, an AC3 interface or a DTS interface. The audio output device 50 can be a car acoustic or a loudspeaker. The video output interface 34 is generally an RGB interface, a CVBS interface or an S-video interface. The display 52 can be a liquid crystal display or a television. The four storage medium interfaces are a flash memory card slot 36, a PCMCIA interface 38, an optical disc drive interface 40 and a hard disk drive interface 42, respectively. The four storage medium interfaces are electrically connected with the general purpose processor 22. The flash memory card slot 36 is used for insertion of a flash memory card 54. The flash memory card slot 36 is compatible with memory cards of different specifications such as Secure Digital (SD), Multi-Media Card (MMC), Smart Media (SM), Memory Stick (MS), Compact Flash (CF), XD Picture and Micro Drive. The PCMCIA interface 38 provides the insertion of a PCMCIA card 56. The optical disc drive interface 40 and the hard disk drive interface 42 are generally IDE or ATAPI interfaces for insertion with an optical disc drive 58 and a hard disk drive 60, respectively. The optical disc formats read/written by the optical disc drive 58 include DVD, VCD, CD and MP3. The optical disc drive 58 and the hard disk drive 60 can also be the same device.

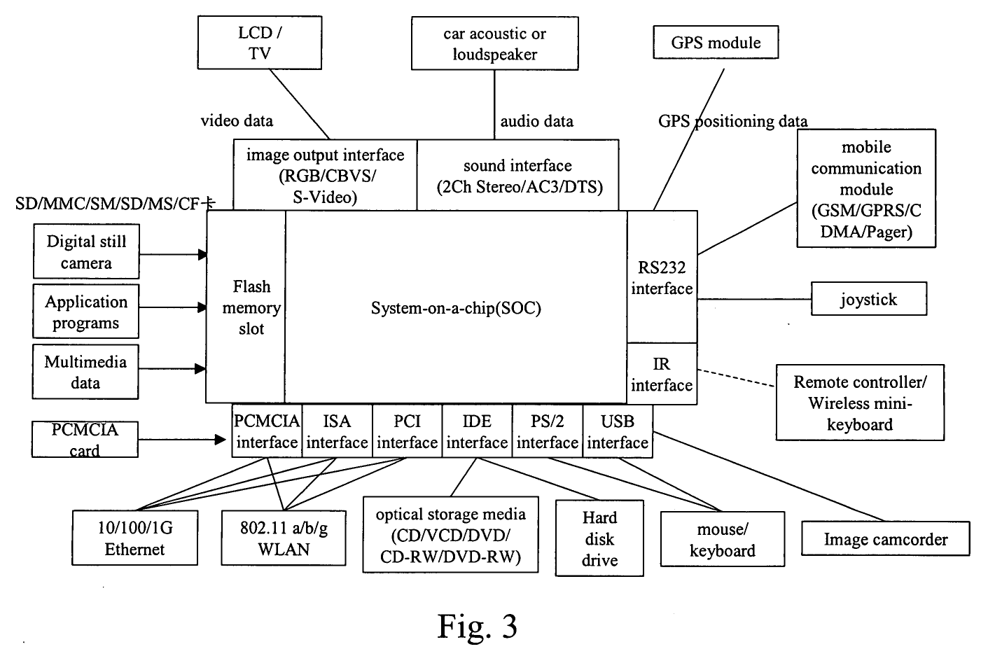

The connection interfaces 44 are connected to the general purpose processor 22 for electric connection with a plurality of external electronic devices 62. The general purpose processor 22 executes the application programs 234 to accomplish signal connection with the electronic devices 62 via the connection interfaces 44. The connection interfaces 44 generally include USB, PCI, IDE, RS232, PS/2, PCMCIA, ISA and IR. The external electronic devices 62 include global positioning system (GPS) modules, mobile communication modules, joysticks, remote controllers, mini-keyboards, tape recorders, mice, and keyboards. The above mobile communication modules include global system mobile (GSM) modules, general packet radio service (GPRS) modules, code division multiple access (CDMA) modules and pagers. The above structures are summarized in FIG. 3 to more clearly illustrate the application system structures of the present invention.

The general purpose processor 22 receives multimedia data from the storage medium interfaces 36, 38, 40 and 42. After decoded and processed by the audio processor 24 and the video processor 26, the encoded video and audio can be displayed in display device 52 and played in the audio output device 50. Furthermore, the general purpose processor 22 can store there multimedia data from the flash memory card 52, the PCMCIA card 54, the optical disc drive 58 or the external device 62 like GPS module into the hard disk drive 60 and to update the multimedia data in the hard disk drive 60 or data of another external device 62.

The present invention will be illustrated with an integrated multimedia microprocessor device 10 integrating multimedia player and GPS navigation below. In this embodiment, a GPS navigation program is included in the application programs 234 executed by the general purpose processor 22. The general purpose processor 22 performs GPS navigation processing including positioning coordinate calculation, navigation route planning, map data search and map display through the GPS navigation program. This integrated multimedia microprocessor device 10 is installed in a car. The audio processor 24 can be used for simultaneous processing of multimedia (e.g., music) playback and GPS navigation and switching between them. During this process, if any important interactions need to remind the car drivers, the music will be interrupted immediately for voice prompts to give the directions. The audio processor 24 then continues to play music after the voice prompts. Besides, the latest map data can be renewed into the hard disk drive 60 through the flash memory card 54 or the optical disc. For instance, map data of some scenic spot or commercial sector can be renewed, hence being capable of providing advertisement and tour guide functions.

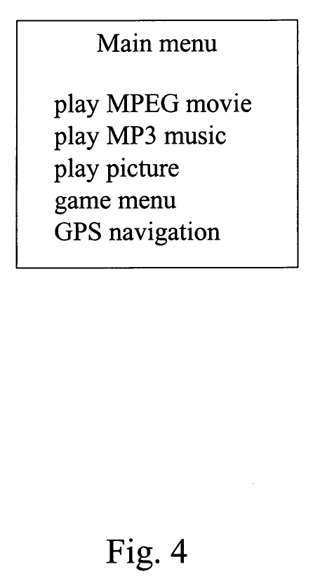

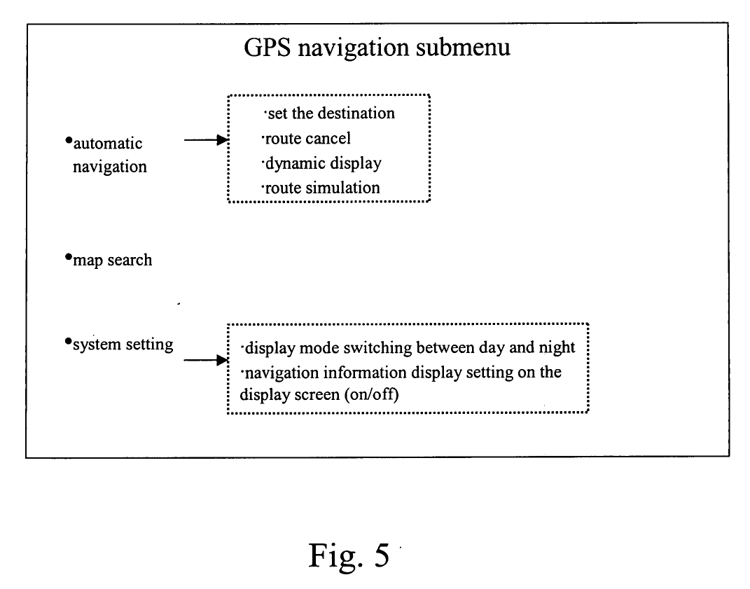

After a user sends out a command via a key module or a remote controller to turn on the integrated multimedia microprocessor device 10, the display 52 will display the main menu frame shown in FIG. 4. Next, the user uses the remote controller to select “the GPS navigation” item. The SOC 20 starts to function and lets the display 52 display the GPS navigation submenu frame shown in FIG. 5. The GPS navigation submenu includes three function items: automatic navigation, map search, and system setting. The automatic navigation includes items like set the destination, route cancel, dynamic route display, route simulation and so on. The “set the destination” item is used to select a site according to administration sectors and facility categories. The “route cancel” item is used to cancel the set navigation route. The dynamic route display item is used to display road names and distances on the planned navigation route. The “route simulation” item is used to simulate the dynamic status of the car according to the planned navigation route.

Besides, the “map search” item can used to select a site for inquiry according to administration sectors and facility categories. The “system setting” item includes two items: display mode switching between day and night and navigation information display setting on the display screen (on/off). After the navigation information display is turned on, the followings can be set: compass, the number of received GPS satellites, the distance and time to the set destination, the street name where the car is, the next intersection name and distance, and so on.

To sum up, the present invention integrates a general purpose processor, a audio processor and an video processor into an SOC and accommodates memory medium interfaces and connection interfaces according to requirements in design to provide an integrated multimedia microprocessor device. A user can select the required electronic devices like a display, a loudspeaker, a navigation module and so on to accomplish the effects of multiple choices of entertainment items and convenient expansibility. Moreover, through the operation of the audio processor, text data like navigation data can be played out with voice.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

1. An integrated multimedia microcomputer device comprising:
a memory for storage of at least an operation system and a plurality of application programs;
a system-on-a-chip including a general purpose processor electrically connected with a audio processor and an video processor, said general purpose processor being used for execution and processing of said operation system and said application programs, said audio processor being used for encoding/decoding and processing of audio data, said video processor being used for encoding/decoding and processing of video data;
a audio/video output interface connected with said audio processor and said video processor for output of said audio and video data;
at least a storage medium interface connected with said general purpose processor for electric connection with at least a memory medium; and
a plurality of connection interfaces connected with said system-on-a-chip for electric connection with a plurality of external electronic devices, said general purpose processor being used to accomplish signal connection with said electronic devices through execution of said application programs.

2. The integrated multimedia microcomputer device as claimed in claim 1, wherein said operation system and said application programs are downloaded from said external electronic devices.

3. The integrated multimedia microcomputer device as claimed in claim 1, wherein said operation system and said application programs are built in said memory.

4. The integrated multimedia microcomputer device as claimed in claim 1, wherein said audio/video output device comprises:
a audio output interface connected with said audio processor for connection with a audio output device for outputting audio; and
an video output interface connected with said video processor for connection with a display for displaying video.

5. The integrated multimedia microcomputer device as claimed in claim 4, wherein said audio output device is selected from the group consisting of a car acoustic and a loudspeaker.

6. The integrated multimedia microcomputer device as claimed in claim 4, wherein said display is selected from the group consisting of a liquid crystal display and a television.

7. The integrated multimedia microcomputer device as claimed in claim 1, wherein said operation system is a real-time operation system.

8. The integrated multimedia microcomputer device as claimed in claim 1, wherein said application programs include a GPS navigation program.

9. The integrated multimedia microcomputer device as claimed in claim 8, wherein said general purpose processor performs a plurality of GPS navigation processing including positioning coordinate calculation, navigation route plan, map data search and map display through said GPS navigation program.

10. The integrated multimedia microcomputer device as claimed in claim 1, which is installed in a car.

11. The integrated multimedia microcomputer device as claimed in claim 1, wherein the audio file format processed by said audio processor is selected from the group consisting of MP3, AC3, DTS, WMA and Karaoke.

12. The integrated multimedia microcomputer device as claimed in claim 1, wherein said audio processor can further perform the conversion from text to voice (Text-to-Speech).

13. The integrated multimedia microcomputer device as claimed in claim 1, wherein said audio processor can further perform the calculation of GPS positioning coordinates.

14. The integrated multimedia microcomputer device as claimed in claim 1, wherein the video file format processed by said video processor is selected from the group consisting of MPEG1, MPEG2, MPEG4, Divx, JPEG, M-JPEG, and WMV.

15. The integrated multimedia microcomputer device as claimed in claim 1, wherein said storage medium is selected from the group consisting of hard disk drive, optical disc drive, and memory card.

16. The integrated multimedia microcomputer device as claimed in claim 15, wherein the format of optical disc read/written by said optical disc drive is selected from the group consisting of DVD, VCD, CD and MP3.

17. The integrated multimedia microcomputer device as claimed in claim 1, wherein said storage medium interface is a memory card slot.

18. The integrated multimedia microcomputer device as claimed in claim 17, wherein said memory card slot can provide insertion of memory cards of different formats.

19. The integrated multimedia microcomputer device as claimed in claim 18, wherein said memory card is selected from the group consisting of Secure Digital card, Multi Media card, Smart Media card, Memory Stick card, Compact Flash card, XD picture card and Micro Drive.

20. The integrated multimedia microcomputer device as claimed in claim 17, wherein said connection interface is selected from the group consisting of USB, PCI, IDE, RS232, PS/2, PCMCIA, ISA and IR.

21. The integrated multimedia microcomputer device as claimed in claim 17, wherein said external electronic device is selected from the group consisting of GPS module, mobile communication module, Joystick, remote controller, mini-keyboard, tape recorder, mouse, and keyboard.

22. The integrated multimedia microcomputer device as claimed in claim 21, wherein said mobile communication module is selected from the group consisting of GSM, GPRS, CDMA and pager.
